(19) United States
(12) Patent Application Publication
(10) Pub. No.: US 2026/0084159 A1
(43) Pub. Date: Mar. 26, 2026

(54) CONE CRUSHER WITH BOTTOM SPRING ADJUSTMENT TYPE MECHANISM

(71) Applicant: ZHEKUANG HEAVY INDUSTRY CO., LTD., Huzhou (CN)

(72) Inventors: Guoqiang Li, Huzhou (CN); Jiulin Wang, Huzhou (CN); Lianghui Di, Huzhou (CN); Mengjun Zhao, Huzhou (CN); Cheng Yuan, Huzhou (CN); Yucheng Chu, Huzhou (CN)

(21) Appl. No.: 19/330,887

(22) Filed: Sep. 17, 2025

(30) Foreign Application Priority Data
Sep. 20, 2024 (CN) 202422300693.8
Mar. 18, 2025 (CN) 202510319876.0

(51) Int. Cl. B02C 2/04

(52) U.S. Cl. CPC B02C 2/047

(57) ABSTRACT

A cone crusher with a bottom spring adjustment type mechanism is provided. The cone crusher includes a bottom frame, an upper frame, an eccentric mechanism arranged on the bottom frame, a main shaft arranged on the eccentric mechanism, a movable cone fixed on the main shaft above the eccentric mechanism, and a fixed cone arranged in the upper frame. A discharge port is formed between the fixed cone and the movable cone. A bottom spring mechanism is arranged in or connected to the bottom frame. An upper end of the bottom spring mechanism elastically supports the main shaft through a thrust bearing unit. By using the bottom spring mechanism to elastically support the main shaft, the solution has the advantages of simple structure, low costs, and convenient maintenance. Furthermore, a problem of wear of a sealing member due to the use of a hydraulic cylinder technology is avoided.

### CROSS REFERENCE TO RELATED APPLICATIONS

The present application claims the benefit of Chinese Patent Application Nos. 202422300693.8 filed on Sep. 20, 2024 and 202510319876.0 filed on Mar. 18, 2025, the contents of which are incorporated herein by reference in their entirety.

### TECHNICAL FIELD

The present disclosure relates to the field of mining machinery, and in particular, to a cone crusher with a bottom spring adjustment type mechanism.

### BACKGROUND

Cone crushers are widely used in industries such as building stone and non-ferrous metal mining. Since these processed objects usually contain material blocks with high hardness, when these material blocks enter a crushing cavity, hard materials can crush a wear-resistant lining plate of the crushing cavity and components of the crusher. Existing solutions for the above problems mainly include upper-frame hydraulic iron passing protection, upper-frame spring iron passing protection, and bottom single-cylinder hydraulic adjustment type iron passing protection. For example, there are the following existing patent solutions:

In terms of iron passing protection and adjustment, a cone crusher described in Chinese patent No. CN113042138B mainly performs a passive lifting action on a plurality of hydraulic cylinders arranged in a circumferential direction between an upper frame and a lower frame to discharge iron blocks.

In terms of iron passing protection and adjustment, a cone crusher described in Chinese patent No. CN211449286U implements iron passing protection by using a distributed spring on an upper frame.

In the above two iron passing protection manners, a iron passing protection mechanism is mounted on the upper frame. When a hard material enters a crushing cavity or materials are accumulated in the crushing cavity, a fixed cone of the crusher is forced to be lifted upwards and compress a spring or a plurality of cylinders, thereby increasing a distance between a movable cone and the fixed cone, so that an ore discharge port is enlarged. The accumulated materials or iron passings are immediately discharged to protect the crusher from being damaged. After the discharging ends, the fixed cone returns to its original position by an elastic force of the spring or a hydraulic pressure. The cone crusher with the above structure has the disadvantages of slow iron passing reaction and low efficiency and that the upper frame and the movable cone structure are easily damaged.

For another example, in terms of iron passing protection and adjustment described Chinese patent No. CN113042138B uses a bottom single-cylinder hydraulic adjustment type iron passing protection structure, which is suitable for an existing single-cylinder cone crusher. This bottom single-cylinder hydraulic adjustment type iron passing protection structure has high usage and maintenance costs and high requirements for a maintenance process. In addition, there is a problem of wear of a sealing member in a hydraulic cylinder technology. Due to its high usage and maintenance costs, this structure is particularly unsuitable for countries or regions with weak industrial foundations.

### SUMMARY

In order to solve the above problems, the present disclosure aims to provide a cone crusher with a bottom spring adjustment type mechanism. By replacing a spring assembly with a bottom single-cylinder hydraulic adjustment type iron passing protection solution, this solution has the advantages of simple structure, low costs, and convenient maintenance. Furthermore, the problem of wear of a sealing member due to the use of the hydraulic cylinder technology is avoided.

In order to achieve the above objective, the present disclosure adopts the following technical solutions:
A cone crusher with a bottom spring adjustment type mechanism includes a bottom frame, an upper frame, an eccentric mechanism arranged on the bottom frame, a main shaft arranged on the eccentric mechanism, a movable cone fixed on the main shaft above the eccentric mechanism, and a fixed cone arranged in the upper frame; a discharge port is formed between the fixed cone and the movable cone; a bottom spring mechanism is arranged in or connected to the bottom frame; and an upper end of the bottom spring mechanism elastically supports the main shaft through a thrust bearing unit.

The present disclosure adopts the above technical solution. This technical solution relates to the cone crusher with the bottom spring adjustment type mechanism. A lower end of the main shaft in the cone crusher is arranged inside the eccentric mechanism, and the movable cone is fixed on the main shaft above the eccentric mechanism. When the eccentric sleeve rotates, the main shaft and the movable cone on the main shaft are driven to swing in a circumferential direction. The discharge port is formed between the fixed cone and the movable cone, and the lower end of the main shaft is supported on the bottom spring mechanism through the thrust bearing unit. After an iron block falls into a crushing cavity of the cone crusher, when the iron block exceeds a size of the discharge port, a force on the entire movable cone suddenly increases. The entire movable cone moves down and pushes a spring assembly of a iron passing protection mechanism, so that the iron block is discharged through the discharge port to implement iron passing protection. After an iron passing action is completed, the spring assembly drives a movable base and the movable cone supported by the movable base to be reset.

By using the bottom spring mechanism to elastically support the main shaft, the cone crusher has the advantages of simple structure, low costs, and convenient maintenance. Furthermore, a problem of wear of a sealing member due to the use of a hydraulic cylinder technology is avoided.

In a specific implementation solution, the bottom spring mechanism includes a sleeve for being fixedly connected to the bottom frame, a spring assembly arranged inside the sleeve, and a movable base arranged above the spring assembly; an upper end of the spring assembly elastically supports the movable base; an upper end surface of the movable base is constructed with a sliding table for supporting the thrust bearing unit; an opening is formed in an upper end of the sleeve and is fixedly connected to the bottom frame; and a lower end of the main shaft is supported on the sliding table through the thrust bearing unit.

The bottom spring adjustment type mechanism is mounted on the bottom frame and replaces the upper-frame hydraulic iron passing protection solution, the upper-frame spring iron passing protection solution, and the bottom single-cylinder hydraulic adjustment type iron passing protection solution that are described in the background section. Specifically, the spring assembly is arranged in the sleeve in the mechanism, and the spring assembly elastically supports the movable base above. The sliding platform of the movable base is configured to support, through the thrust bearing unit, the main shaft mounted on the movable cone. Based on the above solution, the sleeve can guide the rise and fall of the movable base, and the spring assembly can elastically support the movable base. After an iron ore is conveyed into the cone crusher, the iron ore falls into the discharge port, and the entire movable cone moves down to push the spring assembly to implement iron conveying. After the iron conveying is completed, the spring assembly drives the movable base and the movable cone supported by the movable base to be reset.

In one implementation, only one group of spring assembly is provided; the spring assembly is arranged in a center of the sleeve and supports a center of a lower end surface of the movable base. In this solution, one group of large spring assembly is arranged in the center of the sleeve to implement elastic iron passing protection.

In another implementation, a plurality of groups of spring assemblies are connected in parallel, meaning that the plurality of groups of spring assemblies are arranged annularly in a circumferential direction of the center of the sleeve; and upper ends of the plurality of groups of spring assemblies elastically support the movable base. The plurality of groups of spring assemblies provide stable elastic supporting for the movable base, and have higher safety redundancy. For example, when one group of spring assembly has a structural strength defect, other spring assemblies can ensure that the dynamic cone assembly does not fall off.

Preferably, the bottom frame includes a longitudinally extending cylinder portion that extends downwards and an annular plate located above the longitudinally extending portion; a central hole is formed inside the annular plate; the opening in the upper end of the sleeve is fixedly connected to the longitudinally extending cylinder portion; and a top of the sliding table passes through the central hole and is located inside the longitudinally extending cylinder portion of the bottom frame. In this solution, the longitudinally extending cylinder portion is connected to the opening in the upper end of the sleeve form a movement region for the movable base. The top of the sliding table passes through the central hole and is located inside the bottom frame, so that it can be used to support the thrust bearing unit inside the bottom frame.

In a specific implementation, the movable base is slidably arranged inside the sleeve or on the longitudinally extending cylinder portion of the bottom frame connected to the sleeve.

Preferably, the spring assembly includes a spring guide rod and a compression spring sleeving the spring guide rod; a lower end portion of the spring guide rod is directly or indirectly fixed to the sleeve; and an upper end portion of the spring guide rod is threaded into an upper guide rod hole of the movable base. In this solution, a deformation direction of the compression spring is standardized through the guidance of the spring guide rod.

Preferably, a frame guide hole corresponding to the upper guide rod hole is formed in the annular plate; and an upper end portion of the spring guide rod passes through the upper guide rod hole and the frame guide hole. In this way, the upper side of the spring guide rod is positioned through the bottom frame, thereby ensuring stability of positioning of the spring guide rod.

Preferably, a fixed base is arranged inside the sleeve; and a lower end portion of the spring guide rod is threaded into a lower guide rod hole of the fixed base and at least partially extends into a space below the fixed base through the lower guide rod hole. In a specific solution, the space is reserved between the fixed base and a bottom of the sleeve. The lower end portion of the spring guide rod extends into the space through the lower guide rod hole. In this way, a distance of extension of the lower end of the spring guide rod into the lower guide rod hole is long, which can ensure stability of threading and positioning.

Preferably, the sliding table upwards protrudes out of a center of the upper end surface of the movable base; a plurality of upper guide rod holes are arranged on the movable base on a circumferential outer side of the sliding table; an upper end of the spring guide rod is threaded into the upper guide rod holes; an upper spring seat is arranged on the movable base below the upper guide rod hole; and an upper end of the compression spring is positioned inside the upper spring seat. In this solution, the upper guide rod hole avoids the sliding table, and the spring guide rod passes through the upper guide rod hole, so that it can allow the movable base to rise and fall.

In a further solution, the spring guide rod is configured as a screw rod; nuts are arranged at the upper end portion of the spring guide rod that passes through the frame guide hole and the lower end portion that passes through the lower guide rod hole; and a distance between the movable base and the fixed base is adjusted by screwing the nut on an upper side or a lower side, to adjust tightness of the compression spring. In this solution, the device can adjust the tightness of the spring based on different parameter requirements such as material hardness and a crushing specification, to reach a pressure required for material crushing.

In an implementation, the upper frame rises and falls relative to the bottom frame based on a discharge port adjustment mechanism to adjust a port diameter of the discharge port between the fixed cone and the movable cone. In a specific solution, the upper frame is in threaded connection to an upper end of the bottom frame; and the discharge port adjustment mechanism is arranged on the upper frame or the bottom frame to drive the upper frame to rotate, rise, and fall relative to the bottom frame. This solution adjusts a height of the upper frame in a screwing manner and then adjusts the port diameter of the discharge port.

The above discharge port adjustment mechanism can employ a relevant structure described in the invention patent No. “CN104588155B”. For example, a large gear ring sleeves the upper frame, and a driving motor or a rotating hydraulic cylinder that drives the large gear ring to rotate is arranged on the bottom frame.

In a further solution, the upper frame or the bottom frame is further provided with a locking component for locking the upper frame to the bottom frame. The locking component in this solution can be a locking screw rod. After the height of the upper frame has been adjusted relative to the bottom frame, the locking component is used to lock the upper frame, thereby avoiding shaking and displacement of the upper frame and the bottom frame during use of the cone crusher.

In another alternative implementation, a fixed cone adjustment bracket is further arranged inside the upper frame. Specifically, the upper frame is fixed above the bottom frame; a fixed cone adjustment bracket is arranged inside the upper frame; and the fixed cone adjustment bracket rises and falls relative to the upper frame based on the discharge port adjustment mechanism, to adjust a port diameter of the discharge port between the fixed cone and the movable cone. In this solution, the upper frame is fixedly arranged, and the fixed cone adjustment bracket inside is used to longitudinally rise and fall to adjust the port diameter of the discharge port.

In a further solution, the fixed cone adjustment bracket is in threaded connection into the upper frame; and the discharge port adjustment mechanism is arranged on the upper frame or the fixed cone adjustment bracket, to drive the fixed cone adjustment bracket to rotate, rise, and fall relative to the upper frame. Similarly, the above discharge port adjustment mechanism can employ a relevant structure described in the invention patent No. “CN104588155B”. For example, a large gear ring sleeves the fixed cone adjustment bracket, and a driving motor or a rotating hydraulic cylinder that drives the large gear ring to rotate is arranged on the upper frame.

Preferably, the upper frame or the fixed cone adjustment bracket is further provided with a locking component for locking the fixed cone adjustment bracket to the upper frame. The locking component in this solution can be a locking screw rod. After the height of the fixed cone adjustment bracket has been adjusted relative to the upper frame, the locking component is used to lock the fixed cone adjustment bracket, thereby avoiding shaking and displacement of the fixed cone adjustment bracket and the upper frame during use of the cone crusher.

In a further implementation, an upper end of the main shaft swings and is positioned in a main shaft pressing seat in the upper frame or in the fixed cone adjustment bracket. In this solution, the upper end of the main shaft is supported by the main shaft pressing seat. During the swinging of the main shaft, the upper end of the main shaft is supported inside the main shaft pressing seat, thereby improving stability of the main shaft in the swinging process.

In summary, the cone crusher with the bottom spring adjustment type mechanism has the following advantages:
(1) The iron passing protection in this solution is implemented by a bottom spring. When a hard material is in the crushing cavity, the movable cone is stressed and transfers the force to the spring through the main shaft. The spring is compressed to deform to implement the “iron passing” protection.
(2) For the iron passing protection in this solution, the spring extends and contracts to implement the rise and fall of the movable cone during iron passing, so that the problem of the wear of the sealing member in the hydraulic cylinder technology is avoided.
(3) The cone crusher in the technology of the present disclosure implements adjustment of a size of a material ore discharge port and the iron passing protection function through the cooperative use of the bottom spring iron passing protection and the discharge port adjustment mechanism arranged on the upper frame.
(4) The bottom spring iron protection can flexibly implement various combination forms of cone crusher structures, thus improving the diversity and practicality of a product.
(5) Due to the convenience of replacement of the spring and a simple manufacturing process, the maintenance performance of the cone crusher is improved.

### BRIEF DESCRIPTION OF THE DRAWINGS

FIG. 1 is a schematic structural diagram of a bottom spring adjustment type mechanism described in Embodiment 1.

FIG. 2 is a cross-sectional view at A-A in FIG. 1.

FIG. 3 is a radial cross-sectional view of a movable base.

FIG. 4 is a radial cross-sectional view of a fixed base.

FIG. 5 is a first schematic structural diagram of a cone crusher.

FIG. 6 is a second schematic structural diagram of a cone crusher.

### DETAILED DESCRIPTION OF THE EMBODIMENTS

Detail description of the embodiments of present disclosure will be made in the following, and examples thereof are illustrated in the drawings, throughout which identical or similar elements or elements of identical or similar functions are represented with identical or similar reference numerals. The embodiments that are described with reference to the accompanying drawings are exemplary, and are only used to interpret the present disclosure, instead limiting the present disclosure.

In the descriptions of the present disclosure, it should be understood that orientations or positional relationships indicated by the technical terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “clockwise”, “anticlockwise”, and the like are orientations or positional relationships as shown in the drawings, and are only for the purpose of facilitating and simplifying the descriptions of the present disclosure instead of indicating or implying that devices or elements indicated must have particular orientations, and be constructed and operated in the particular orientations, so that these terms are not construed as limiting the present disclosure.

In addition, the terms “first” and “second” are used for descriptive purposes only and are not to be construed as indicating or implying relative importance or to implicitly indicate the number of technical features indicated. From this, features defined as “first” and second“ may explicitly or implicitly include one or more features. In the description of the present disclosure, “plurality”means two or more, unless otherwise expressly and specifically defined.

In the present disclosure, unless otherwise expressly specified and limited, the terms “mount”, “link”, “connect”, “fix”, and the like should be understood in a broad sense, such as, a fixed connection, a detachable connection, an integrated connection, a mechanical connection, an electrical connection, a direct connection, an indirect connection through an intermediate medium, and an internal communication of two elements. A person of ordinary skill in the art may understand the specific meanings of the foregoing terms in the present disclosure according to specific situations.

In the present disclosure, unless otherwise explicitly stipulated and restricted, that a first feature is “on” or “under” a second feature may include that the first and second features are in direct contact, or may include that the first and second features are in indirect contact through another feature. In addition, that the first feature is “on”, “above”, or “over” the second feature includes that the first feature is directly or diagonally above the second feature, or merely indicates that a level of the first feature is greater than that of the second feature. That the first feature is “below”, “beneath”, and “under” of the second feature indicates that the first feature is directly or diagonally below the second feature, or merely indicates that a level of the first feature is less than that of the second feature.

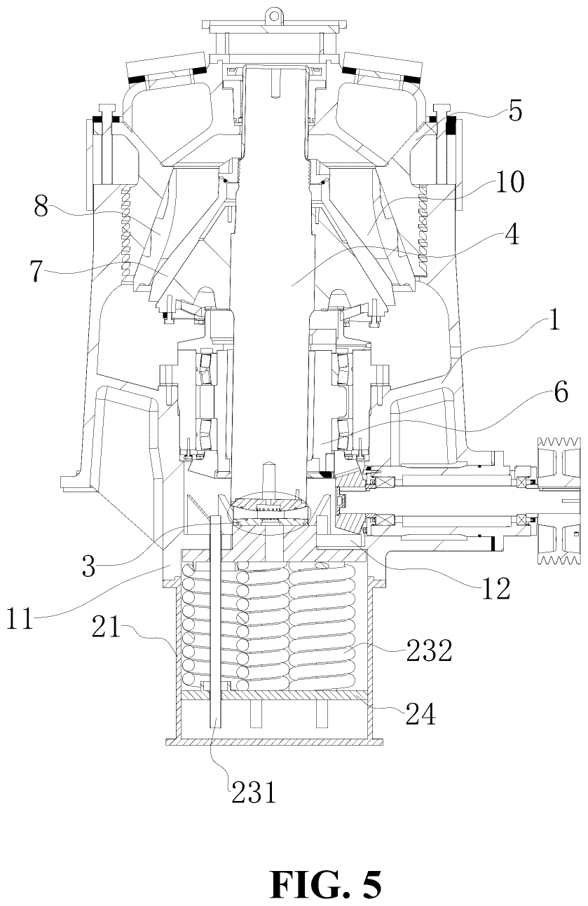

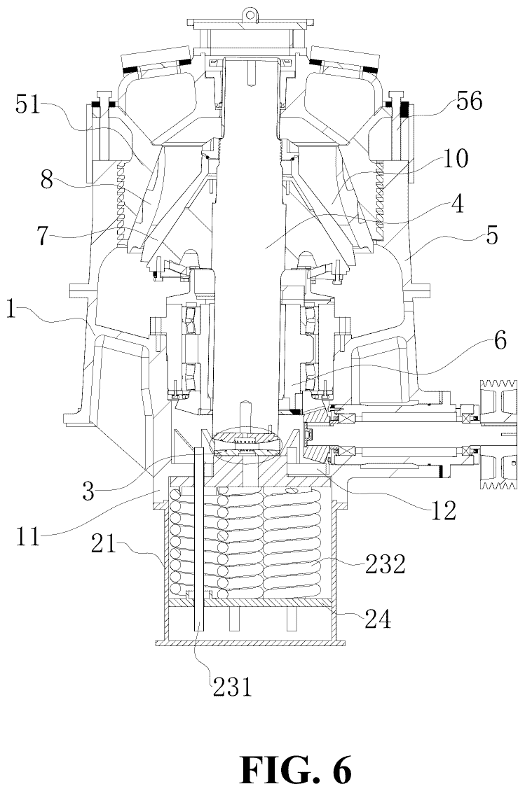

As shown in FIG. 5 and FIG. 6, this implementation relates to a cone crusher with a bottom spring adjustment type mechanism, including a bottom frame 1, an upper frame 5, an eccentric mechanisms 6 arranged on the bottom frame 1, a main shaft 4 arranged on the eccentric mechanism 6, a movable cone 7 fixed on the main shaft 4 above the eccentric mechanism 6, and a fixed cone 8 arranged in the upper frame 5. A discharge port 10 is formed between the fixed cone 8 and the movable cone 7.

Compared with the solution in the existing art, this solution has the characteristic that a bottom spring mechanism is arranged in or connected to the bottom frame 1; and an upper end of the bottom spring mechanism elastically supports the main shaft 4 through a thrust bearing unit 3. A lower end of the main shaft in the cone crusher is arranged inside the eccentric mechanism, and the movable cone is fixed on the main shaft above the eccentric mechanism. When the eccentric sleeve rotates, the main shaft and the movable cone on the main shaft are driven to swing in a circumferential direction. The discharge port is formed between the fixed cone and the movable cone, and the lower end of the main shaft is supported on the bottom spring mechanism through the thrust bearing unit. After an iron block is conveyed into the cone crusher, when the iron block exceeds a size of the discharge port, a force on the entire movable cone suddenly increases because the iron block cannot be broken. The entire movable cone moves down and pushes a spring assembly of a iron passing protection mechanism, so that the iron block is discharged through the discharge port to implement iron passing protection. After an iron passing action is completed, the spring assembly drives a movable base and the movable cone supported by the movable base to be reset. By using the bottom spring mechanism to elastically support the main shaft, the cone crusher has the advantages of simple structure, low costs, and convenient maintenance. Furthermore, a problem of wear of a sealing member due to the use of a hydraulic cylinder technology is avoided.

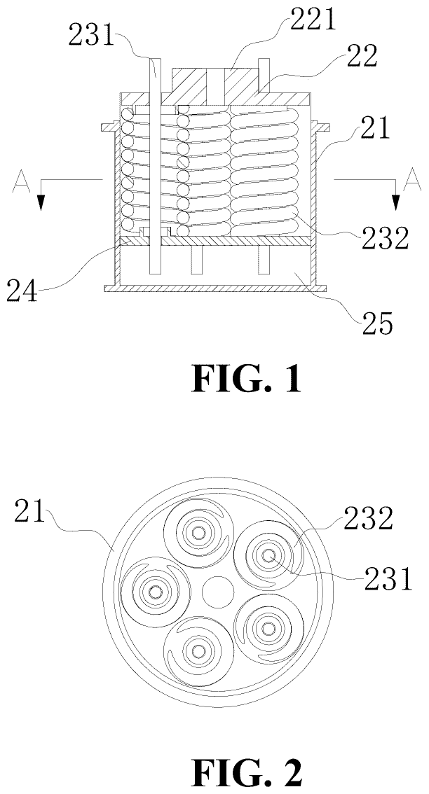

In a specific implementation solution shown in FIG. 1 to FIG. 4, the bottom spring mechanism includes a sleeve 21 for being fixedly connected to the bottom frame 1, a spring assembly arranged inside the sleeve 21, and a movable base 22 arranged above the spring assembly; an upper end of the spring assembly elastically supports the movable base 22; an upper end surface of the movable base 22 is constructed with a sliding table 221 for supporting the thrust bearing unit 3; an opening is formed in an upper end of the sleeve 21 and is fixedly connected to the bottom frame 1; and a lower end of the main shaft 4 is supported on the sliding table 221 through the thrust bearing unit 3. The bottom spring adjustment type mechanism is mounted on the bottom frame and replaces the upper-frame hydraulic iron passing protection solution, the upper-frame spring iron passing protection solution, and the bottom single-cylinder hydraulic adjustment type iron passing protection solution that are described in the background section. Specifically, the spring assembly is arranged in the sleeve in the mechanism, and the spring assembly elastically supports the movable base above. The sliding platform of the movable base is configured to support, through the thrust bearing unit, the main shaft mounted on the movable cone. Based on the above solution, the sleeve can guide the rise and fall of the movable base, and the spring assembly can elastically support the movable base. After an iron block is conveyed into the cone crusher, iron ores fall into the discharge port, and the entire movable cone moves down to push the spring assembly to implement iron conveying. After the iron conveying is completed, the spring assembly drives the movable base and the movable cone supported by the movable base to be reset.

As shown in FIG. 5 and FIG. 6, the bottom frame 1 includes a longitudinally extending cylinder portion 11 that extends downwards and an annular plate 12 located above the longitudinally extending portion; a central hole is formed inside the annular plate 12; the opening in the upper end of the sleeve 21 is fixedly connected to the longitudinally extending cylinder portion 11; and a top of the sliding table 221 passes through the central hole and is located inside the longitudinally extending cylinder portion 11 of the bottom frame. In this solution, the longitudinally extending cylinder portion is connected to the opening in the upper end of the sleeve form a movement region for the movable base. The top of the sliding table passes through the central hole and is located inside the bottom frame, so that it can be used to support the thrust bearing unit inside the bottom frame. The movable base 22 is slidably arranged inside the sleeve 21 or on the longitudinally extending cylinder portion 11 of the bottom frame connected to the sleeve 21.

In one implementation, only one group of spring assembly is provided; the spring assembly is arranged in a center of the sleeve 21 and supports a center of a lower end surface of the movable base 22. In this solution, one group of large spring assembly is arranged in the center of the sleeve to implement elastic iron passing protection.

In another implementation shown in FIG. 1, a plurality of groups of spring assemblies are connected in parallel, meaning that the plurality of groups of spring assemblies are arranged annularly in a circumferential direction of the center of the sleeve 21; and upper ends of the plurality of groups of spring assemblies elastically support the movable base 22. The plurality of groups of spring assemblies provide stable elastic supporting for the movable base, and have higher safety redundancy. For example, when one group of spring assembly has a structural strength defect, other spring assemblies can ensure that the dynamic cone assembly does not fall off.

As shown in FIG. 1, the spring assembly includes a spring guide rod 231 and a compression spring 232 sleeving the spring guide rod 231; a lower end portion of the spring guide rod 231 is directly or indirectly fixed to the sleeve 21; and an upper end portion of the spring guide rod 231 is threaded into an upper guide rod hole 222 of the movable base 22. In this solution, a deformation direction of the compression spring is standardized through the guidance of the spring guide rod. A frame guide hole corresponding to the upper guide rod hole 222 is formed in the annular plate 12 in the bottom frame 1; and an upper end portion of the spring guide rod 231 passes through the upper guide rod hole 222 and the frame guide hole. In this way, the upper side of the spring guide rod is positioned through the bottom frame, thereby ensuring stability of positioning of the spring guide rod.

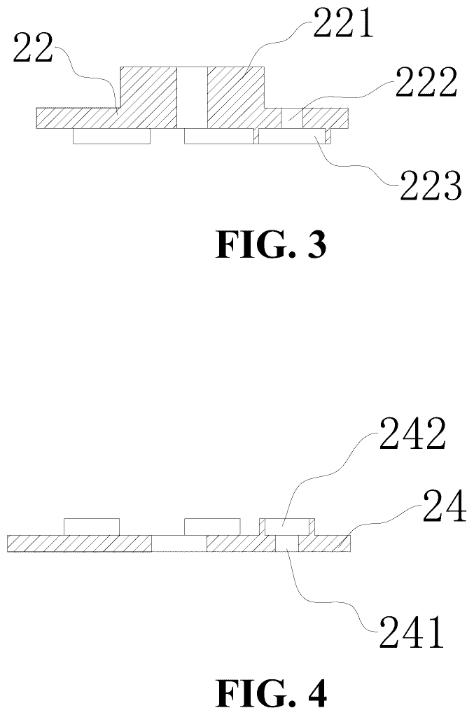

As shown in FIG. 1, a fixed base 24 is arranged inside the sleeve 21; and a lower end portion of the spring guide rod 231 is threaded into a lower guide rod hole 241 of the fixed base 24 and at least partially extends into a space below the fixed base 24 through the lower guide rod hole 241. In a specific solution, the space is reserved between the fixed base and a bottom of the sleeve. The lower end portion of the spring guide rod extends into the space through the lower guide rod hole. In this way, a distance of extension of the lower end of the spring guide rod into the lower guide rod hole is long, which can ensure stability of threading and positioning. As shown in FIG. 1 and FIG. 3, the sliding table 221 upwards protrudes out of a center of the upper end surface of the movable base 22; a plurality of upper guide rod holes 222 are arranged on the movable base 22 on a circumferential outer side of the sliding table 221; an upper end of the spring guide rod 231 is threaded into the upper guide rod holes 222; an upper spring seat 223 is arranged on the movable base 22 below the upper guide rod hole 222; and an upper end of the compression spring 232 is positioned inside the upper spring seat 223. In this solution, the upper guide rod hole avoids the sliding table, and the spring guide rod passes through the upper guide rod hole, so that it can allow the movable base to rise and fall.

To mount the bottom spring adjustment type mechanism, the fixed base 24 is first mounted at an appropriate position at the bottom of the sleeve 21. Then, the spring guide rod 231 is arranged on five lower guide rod holes 241 of the fixed base 24. Next, the compression spring 232 is mounted on the lower spring seat 242 of the fixed base 24. Finally, the upper guide rod hole 222 on the movable base 22 is aligned with the spring guide rod 231 for mounting, and the upper spring seat 223 is aligned with the compression spring 232 for mounting and tightening to complete the assembling of the bottom spring adjustment mechanism. Then, the bottom spring adjustment type mechanism is mounted onto the bottom frame 1. The longitudinally extending cylinder portion of the bottom frame 1 is connected to the opening of the upper end of the sleeve 21, for example, in a manner of welding or flange plate connection. The spring guide rod 231 passes through the frame guide hole. In this way, the upper side of the spring guide rod is positioned through the bottom frame, thereby ensuring stability of positioning of the spring guide rod. In a further preferred solution, the spring guide rod 231 is configured as a screw rod; nuts are arranged at the upper end portion of the spring guide rod 231 that passes through the frame guide hole and the lower end portion that passes through the lower guide rod hole 241; and a distance between the movable base 22 and the fixed base 24 can be adjusted by screwing the nut on an upper side or a lower side, to adjust tightness of the compression spring 232. In this solution, the device can adjust the tightness of the spring based on different parameter requirements such as material hardness and a crushing specification, to reach a pressure required for material crushing.

As shown in FIG. 5, in an implementation, the upper frame 5 can rise and fall relative to the bottom frame 1 based on a discharge port adjustment mechanism to adjust a port diameter of the discharge port 10 between the fixed cone 8 and the movable cone 7. In a specific solution, the upper frame 5 is in threaded connection to an upper end of the bottom frame 1; and the discharge port adjustment mechanism is arranged on the upper frame 5 or the bottom frame 1 to drive the upper frame 5 to rotate, rise, and fall relative to the bottom frame 1. This solution adjusts a height of the upper frame in a screwing manner and then adjusts the port diameter of the discharge port 10. The above discharge port adjustment mechanism can employ a relevant structure described in the invention patent No. “CN104588155B”. For example, a large gear ring sleeves the upper frame 5, and a driving motor or a rotating hydraulic cylinder that drives the large gear ring to rotate is arranged on the bottom frame 1.

In a further solution, the upper frame 5 or the bottom frame 1 is further provided with a locking component 56 for locking the upper frame 5 to the bottom frame 1. The locking component 56 in this solution can be a locking screw rod. After the height of the upper frame 5 has been adjusted relative to the bottom frame 1, the locking component 56 is used to lock the upper frame 5, thereby avoiding shaking and displacement of the upper frame 5 and the bottom frame 1 during use of the cone crusher.

In another alternative implementation shown in FIG. 6, a fixed cone adjustment bracket 51 is further arranged inside the upper frame 5. Specifically, the upper frame 5 is fixed above the bottom frame 1; a fixed cone adjustment bracket 51 is arranged inside the upper frame 5; and the fixed cone adjustment bracket 51 rises and falls relative to the upper frame 5 based on the discharge port adjustment mechanism, to adjust a port diameter of the discharge port 10 between the fixed cone 8 and the movable cone 7. In this solution, the upper frame 5 is fixedly arranged, and the fixed cone adjustment bracket 51 inside is used to longitudinally rise and fall to adjust the port diameter of the discharge port 10. In a further solution, the fixed cone adjustment bracket 51 is in threaded connection into the upper frame 5; and the discharge port adjustment mechanism is arranged on the upper frame 5 or the fixed cone adjustment bracket 51, to drive the fixed cone adjustment bracket 51 to rotate, rise, and fall relative to the upper frame 5. Similarly, the above discharge port adjustment mechanism can employ a relevant structure described in the invention patent No. “CN104588155B”. For example, a large gear ring sleeves the fixed cone adjustment bracket 51, and a driving motor or a rotating hydraulic cylinder that drives the large gear ring to rotate is arranged on the upper frame 5.

Preferably, the upper frame 5 or the fixed cone adjustment bracket 51 is further provided with a locking component 56 for locking the fixed cone adjustment bracket 51 to the upper frame 5. The locking component 56 in this solution can be a locking screw rod. After the height of the fixed cone adjustment bracket 51 has been adjusted relative to the upper frame 5, the locking component 56 is used to lock the fixed cone adjustment bracket 51, thereby avoiding shaking and displacement of the fixed cone adjustment bracket 51 and the upper frame 5 during use of the cone crusher.

In the above two solutions, an upper end of the main shaft 4 swings and is positioned in a main shaft pressing seat in the upper frame 5 or in the fixed cone adjustment bracket 51. In this solution, the upper end of the main shaft 4 is supported by the main shaft pressing seat. During the swinging of the main shaft, the upper end of the main shaft is supported inside the main shaft pressing seat, thereby improving stability of the main shaft in the swinging process.

In summary, the cone crusher with the bottom spring adjustment type mechanism has the following advantages:
(1) The iron passing protection in this solution is implemented by a bottom spring. When a hard material is in the crushing cavity, the main shaft of the movable cone is stressed and transfers the force to the spring. The spring is compressed to deform to implement the “iron passing” protection.
(2) For the iron passing protection in this solution, the spring extends and contracts to implement the rise and fall of the movable cone during iron passing, so that the problem of the wear of the sealing member in the hydraulic cylinder technology is avoided.
(3) The cone crusher in the technology of the present disclosure implements material adjustment and the iron passing protection function through the cooperative use of the bottom spring iron passing protection and the discharge port adjustment mechanism arranged on the upper frame.
(4) The bottom spring iron protection can flexibly implement various combination forms of cone crusher structures, thus improving the diversity and practicality of a product.
(5) Due to the convenience of replacement of the spring and a simple manufacturing process, the maintenance performance of the cone crusher is improved.

In the description of this specification, the description referring to the terms “one embodiment”, “some embodiments”, “an example”, “specific examples”, “some examples”, or the like means that specific features, structures, materials or characteristics described in connection with the embodiments or examples are included in at least one embodiment or example of the present disclosure. In this specification, the schematic representations of the above terms are not necessarily intended to refer to the same embodiment or example. Furthermore, the specific features, structures, materials or characteristics described may be combined in any suitable manner in any one or more embodiments or examples.

The embodiments of the present disclosure have been shown and described above, but it can be understood that the above embodiments are exemplary and cannot be understood as limitations on the present disclosure. A person of ordinary skill in the art may make changes, modifications, substitutions, and transformations to the above embodiments within the scope of the present disclosure without departing from the principle and purpose of the present disclosure.

What is claimed is:

1. A cone crusher with a bottom spring adjustment type mechanism, comprising a bottom frame (1), an upper frame (5), an eccentric mechanism (6) arranged on the bottom frame (1), a main shaft (4) arranged on the eccentric mechanism (6), a movable cone (7) fixed on the main shaft (4) above the eccentric mechanism (6), and a fixed cone (8) arranged in the upper frame (5), wherein a discharge port (10) is formed between the fixed cone (8) and the movable cone (7); a bottom spring mechanism is arranged in or connected to the bottom frame (1); and an upper end of the bottom spring mechanism elastically supports the main shaft (4) through a thrust bearing unit (3).

2. The cone crusher with the bottom spring adjustment type mechanism according to claim 1, wherein the bottom spring mechanism comprises a sleeve (21) for being fixedly connected to the bottom frame (1), a spring assembly arranged inside the sleeve (21), and a movable base (22) arranged above the spring assembly; an upper end of the spring assembly elastically supports the movable base (22); an upper end surface of the movable base (22) is constructed with a sliding table (221) for supporting the thrust bearing unit (3); an opening is formed in an upper end of the sleeve (21) and is fixedly connected to the bottom frame (1); and a lower end of the main shaft (4) is supported on the sliding table (221) through the thrust bearing unit (3).

3. The cone crusher with the bottom spring adjustment type mechanism according to claim 2, wherein only one group of spring assembly is provided; the spring assembly is arranged in a center of the sleeve (21) and supports a center of a lower end surface of the movable base (22); or, a plurality of groups of spring assemblies are connected in parallel, meaning that the plurality of groups of spring assemblies are arranged annularly in a circumferential direction of the center of the sleeve (21); and upper ends of the plurality of groups of spring assemblies elastically support the movable base (22).

4. The cone crusher with the bottom spring adjustment type mechanism according to claim 2, wherein the bottom frame (1) comprises a longitudinally extending cylinder portion (11) that extends downwards and an annular plate (12) located above the longitudinally extending portion; a central hole is formed inside the annular plate (12); the opening in the upper end of the sleeve (21) is fixedly connected to the longitudinally extending cylinder portion (11); and a top of the sliding table (221) passes through the central hole and is located inside the longitudinally extending cylinder portion (11) of the bottom frame.

5. The cone crusher with the bottom spring adjustment type mechanism according to claim 4, wherein the movable base (22) is slidably arranged inside the sleeve (21) or on the longitudinally extending cylinder portion (11) of the bottom frame connected to the sleeve (21).

6. The cone crusher with the bottom spring adjustment type mechanism according to claim 3, wherein the spring assembly comprises a spring guide rod (231) and a compression spring (232) sleeving the spring guide rod (231); a lower end portion of the spring guide rod (231) is directly or indirectly fixed to the sleeve (21); and an upper end portion of the spring guide rod (231) is threaded into an upper guide rod hole (222) of the movable base (22).

7. The cone crusher with the bottom spring adjustment type mechanism according to claim 6, wherein a frame guide hole corresponding to the upper guide rod hole (222) is formed in the annular plate (12); and an upper end portion of the spring guide rod (231) passes through the upper guide rod hole (222) and the frame guide hole.

8. The cone crusher with the bottom spring adjustment type mechanism according to claim 7, wherein a fixed base (24) is arranged inside the sleeve (21); and a lower end portion of the spring guide rod (231) is threaded into a lower guide rod hole (241) of the fixed base (24) and at least partially extends into a space below the fixed base (24) through the lower guide rod hole (241).

9. The cone crusher with the bottom spring adjustment type mechanism according to claim 6, wherein the sliding table (221) upwards protrudes out of a center of the upper end surface of the movable base (22); a plurality of upper guide rod holes (222) are arranged on the movable base (22) on a circumferential outer side of the sliding table (221); an upper end of the spring guide rod (231) is threaded into the upper guide rod holes (222); an upper spring seat (223) is arranged on the movable base (22) below the upper guide rod hole (222); and an upper end of the compression spring (232) is positioned inside the upper spring seat (223).

10. The cone crusher with the bottom spring adjustment type mechanism according to claim 8, wherein the spring guide rod (231) is configured as a screw rod; nuts are arranged at the upper end portion of the spring guide rod (231) that passes through the frame guide hole and the lower end portion that passes through the lower guide rod hole (241); and a distance between the movable base (22) and the fixed base (24) is adjusted by screwing the nut on an upper side or a lower side, to adjust tightness of the compression spring (232).

11. The cone crusher with the bottom spring adjustment type mechanism according to claim 1, wherein the upper frame (5) rises and falls relative to the bottom frame (1) based on a discharge port adjustment mechanism to adjust a port diameter of the discharge port (10) between the fixed cone (8) and the movable cone (7).

12. The cone crusher with the bottom spring adjustment type mechanism according to claim 11, wherein the upper frame (5) is in threaded connection to an upper end of the bottom frame (1);
and the discharge port adjustment mechanism is arranged on the upper frame (5) or the bottom frame (1) to drive the upper frame (5) to rotate, rise, and fall relative to the bottom frame (1).

13. The cone crusher with the bottom spring adjustment type mechanism according to claim 11, wherein the upper frame (5) or the bottom frame (1) is further provided with a locking component (56) for locking the upper frame (5) to the bottom frame (1).

14. The cone crusher with the bottom spring adjustment type mechanism according to claim 1, wherein the upper frame (5) is fixed above the bottom frame (1); a fixed cone adjustment bracket (51) is arranged inside the upper frame (5); and the fixed cone adjustment bracket (51) rises and falls relative to the upper frame (5) based on the discharge port adjustment mechanism, to adjust a port diameter of the discharge port (10) between the fixed cone (8) and the movable cone (7).

15. The cone crusher with the bottom spring adjustment type mechanism according to claim 14, wherein the fixed cone adjustment bracket (51) is in threaded connection into the upper frame (5); and the discharge port adjustment mechanism is arranged on the upper frame (5) or the fixed cone adjustment bracket (51), to drive the fixed cone adjustment bracket (51) to rotate, rise, and fall relative to the upper frame (5).

16. The cone crusher with the bottom spring adjustment type mechanism according to claim 14, wherein the upper frame (5) or the fixed cone adjustment bracket (51) is further provided with a locking component (56) for locking the fixed cone adjustment bracket (51) to the upper frame (5).

17. The cone crusher with the bottom spring adjustment type mechanism according to claim 11, wherein an upper end of the main shaft (4) swings and is positioned in a main shaft pressing seat in the upper frame (5) or in the fixed cone adjustment bracket (51).
